(19) United States
(12) Patent Application Publication
(10) Pub. No.: US 2026/0212736 A1
(43) Pub. Date: Jul. 23, 2026

(54) AUTOMATED TELLER MACHINE FOR AUTOMATIC SUPPLYING OF COUNTER SERVICES

(71) Applicant: SECRETEL SERVICE S.R.L., Segrate (IT)

(72) Inventor: Franco IANNELLI, Isernia (IT)

(21) Appl. No.: 19/144,480

(22) PCT Filed: Jan. 2, 2024
(86) PCT No.: PCT/IB2024/050025

§ 371 Date: Jun. 29, 2025

(30) Foreign Application Priority Data
Dec. 30, 2022 (IT) 102022000027282

(51) Int. Cl. G07F 19/00

(52) U.S. Cl. CPC G07F 19/201; G07F 19/202; G07F 19/203; G07F 19/205; G07F 19/206

(57) ABSTRACT

An automatic or unmanned teller machine having an apparatus for the acquisition and supply of documents for the provision of services and which comprises a supporting structure, means for the optical acquisition of documents, means for processing the acquired documents, means for supplying documents and at least one port for insertion by a user of documents to feed said acquisition means and for supplying documents to the same user by said supplying means.

### TECHNICAL FIELD

The present invention finds application in the field of devices for the management of documents and particularly has as its object an automatic or unattended teller machine for the automatic provision of teller or counter services of any kind to one or more users, in an unmanned way or by means of remotely operating operators, wherein the teller machine is provided with an apparatus for the automatic acquisition and release of documents.

### STATE OF THE ART

Automatic or semi-automatic teller machines are known, also as kiosks, and designed to allow the provision of services to users without the need for the presence of an operator on site.

These machines may operate completely automatically or through the remote assistance of an operator for providing, for example, information and/or documents to citizens.

The teller machines are used in several fields, both public and private, in order to provide specific information to a user and possibly allow the printing of documents or the sending of information by the same user to a central manager.

For example, one of the possible applications requires the machine to be set up within public offices, such as registry offices, schools and universities, to allow the reception of specific or generic information and possibly printing official documentation.

A first drawback of these known solutions is represented by the fact that these systems, essentially static in nature, are severely limited in their functionality, not allowing the user to receive a personalized service that goes beyond the pre-set information inside the machine.

It follows that for the provision of specific and more complex services, such as for example a request for installments to a collection agency, or even to carry out verification steps, accept payments and issue receipts or other types of requests for a customizable service depending on the user's needs, it is always necessary to go to a physical counter manned locally by an operator.

A further drawback is then represented by the fact that these systems require a user to have an operating mode substantially different from that of a normal office counter manned by an operator, with the need for interactions with a computer which are not always immediately understandable.

In fact, the well-known teller machines usually provide for the presence of a guiding voice or a sign or a light bar that indicates the place where a document can be inserted or withdrawn.

Therefore, this feature represents a notable limitation for people with little habit of using electronic devices, in particular for older people, as it makes the experience unnatural, significantly limiting the spread of unattended teller machines.

IT201800005835, in the name of the same Applicant, describes an automatic teller machine for the provision of counter services equipped with means for the optical acquisition of documents.

The configuration of the acquisition means is such that the user is required to place the document to be acquired at specific instrument, such as a video camera.

This solution is also not very practical and intuitive, especially for older users or those not used to operate with electronic devices.

CN212322368 discloses a self-service machine for service delivery provided with a facial recognition camera, a high-fidelity speaker, a touch display and an electronic card reader port. The machine also comprises an ID card reader, a writing board, a fingerprint instrument recognizer, a keyboard, a printer.

Also in this case, the means for acquisition of documents do not allow the user to operate in a similar way to what happens in common physical counters manned by an operator.

### SCOPE OF THE INVENTION

The object of the present invention is to overcome the above-mentioned drawbacks by providing an automatic or unmanned teller machine for supplying services which is provided with an apparatus for the acquisition and issuing of documents which allows any user, even if not particularly used to electronic devices or in any case not guided by an operator in person, to use the service in a simple and intuitive way and completely similar to what would happen if there was an operator present on site.

Yet another object is to provide such a machine which allows the user to remotely access any service, such as a consultancy service, provision or sending of documents or any other type of service commonly provided by a public or private entity, always allowing to communicate with an operator, real or even virtual or generated by artificial intelligence, in a manner substantially identical to what would happen at a manned local desk.

Yet another object is to provide a machine for the provision of remote services having the above apparatus and which allows a public or private entity authorized to supply services to the citizen to make the service always available, reducing the related costs for staff and facilities.

Yet another object is to make available such a machine which allows a public or private entity authorized to supply services to the citizen to simultaneously manage multiple offices through a limited, if not zero, number of operators, reducing or eliminating at the same time the queues.

These objects, as well as others that will become more apparent hereinafter, are achieved by a teller machine in accordance with claim 1, to which reference is made for greater conciseness of the explanation.

Thanks to the possibility of not having different reception and insertion areas scattered on the desk, as with the solutions currently on the market, the natural interaction of the user with the machine will be considerably simplified and more intuitive.

As matter of fact, the teller machine will make it possible to reproduce the functionality of the typical manned desk equipped with glass or a separation panel between the operator and the user and having, in a central position, a slot made in the panel to facilitate the passage of documents in both the directions.

The device may be mounted on any type of kiosk or remote office desk, to make it possible, with natural and immediate functions, the passage of documents even to operators operating remotely.

In this text, the terms desk, kiosk or even totem will be used in an alternative and equivalent manner to each other and will indicate a generally fixed structure, but possibly also transportable, designed like any desk present in public offices, i.e. with a supporting structure provided of a support surface for documents and a separation panel between the user and the virtual operator.

The separation panel will be suitably transparent and will separate the user from a screen or monitor in which the image of the operator operating remotely will be reproduced.

The image may be the real one of the operator, taken by a camera associated with the operator's local workstation and transmitted to the monitor, or a holographic image or, again, the projection of a virtual operator, which may also be generated by artificial intelligence.

The presence of the single port placed under a separation panel will make the document insertion and removal phase natural and will make the experience very different from the approach with a scanner to be used by opening the lid, activating the scan button, or with other modern devices of document acquisition present in some offices.

The desk so designed may be inserted into a remote management system of unmanned local teller machines which will make it possible to remotely manage a plurality of local desks with a reduced number of operators, avoiding the operators must control a desk even in absence of users, so as to manage downtime, optimize resources and at the same time guarantee full and efficient operation of the teller machine.

Moreover, the possibility that an operator, real or virtual, operating remotely can receive the document in real time in his CRM, view it and discuss it with the customer, helps to facilitate the perception of a traditional desk, compared to other existing structures that prefer file transfer via email.

In this way, again, it will be possible to productively rationalize the resources necessary to provide the service, in particular the need and costs of personnel, but without reducing the quality of the service in terms of waiting times, quality and perception of attention received from the user as the video presence means of communication will simulate the presence of a local operator inside an office desk separated by protective glass.

Advantageous embodiments of the invention are obtained in accordance with the dependent claims.

### BRIEF DISCLOSURE OF THE DRAWINGS

Further features and advantages of the invention will become more apparent in the light of the detailed description of preferred but not exclusive embodiments of an automatic or unattended teller machine according to the invention, illustrated by way of non-limiting example with the aid of the attached drawing tables, wherein:

FIG. 1 is a partial perspective view of the machine wherein the document acquisition and issuing apparatus is visible;

FIG. 2 is a partial perspective view of the apparatus of FIG. 1 partially open for viewing thereinside;

FIG. 3 is a top view of the apparatus of FIG. 1;

FIG. 4 is a side view of the apparatus of FIG. 1;

FIG. 5 is a side view of a variant of the apparatus of FIG. 1;

FIG. 6 is a side view of a further variant of the apparatus of FIG. 1;

FIG. 7 is a top view of the apparatus according to a different configuration;

FIG. 8 is a schematic view of a system comprising a plurality of machines provided with an apparatus for acquiring and issuing documents in accordance with the present invention.

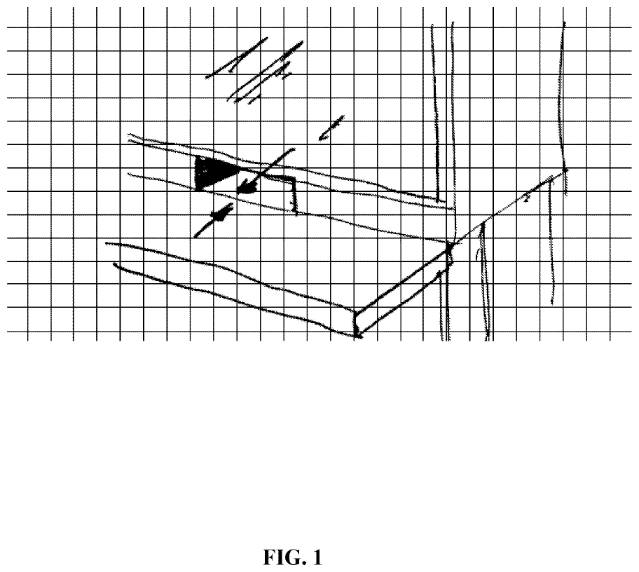

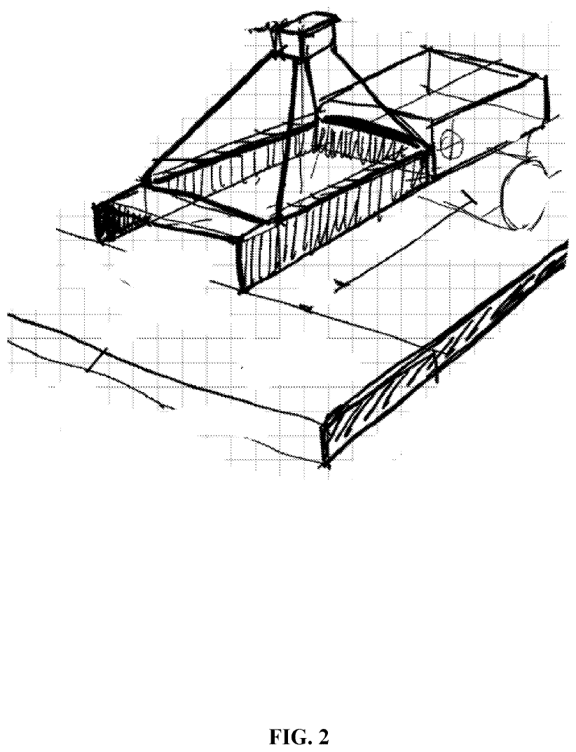

### BEST MODES OF CARRYING OUT THE INVENTION

With reference to the attached figures, a schematic and partial configuration of an automatic or unattended teller machine for the provision of services to a user is shown, which machine being provided with an apparatus for the acquisition and issuing of documents according to the present invention.

The apparatus, generically referred as 10, may be implemented inside any automatic or unmanned counter locally or, furtherly, manned by a remote operator, and that will be suitable to provide any kind of service, both for the Public Administration or other public bodies, as well as in the context of services provided by private entities.

In particular, the apparatus 10 may also be implemented in a traditional type of counter to automate its operation or part of the functions.

The apparatus 10 essentially comprises a supporting structure 20 which houses optical acquisition means 30 for the optical acquisition of documents, processing means 40 for processing the acquired documents, not shown, and supplying means 50 for supplying documents.

Furthermore, the supporting structure 20 has at least one port for the insertion by a user of the documents which have to be acquired by the optical acquisition means 30 and at least one port for the supplying the documents to the same user by the supplying means 50.

The supplied documents may be the same documents previously acquired by the optical acquisition means 30 and processed by the processing means 40, or they may be new documents produced by the supplying means 50, possibly on the basis of the acquired documents or on the basis of specific requests and information provided by the user.

Preferably, the supporting structure 20 will comprise a single port 60 through which both the insertion of the documents towards the optical acquisition means 30 and the supplying of the documents to the user will take place.

According to a particularly preferred configuration, the supporting structure 20 may be provided with a separation panel 70 which will simulate the separation panel of a common local counter.

The separation panel 70 may be at least partly transparent and provided with a support surface 100 for the documents and with the above port which will substantially simulate the cut in the glass or Plexiglass barrier separation panel typically used in the office counter of public or private agencies for separate the user from the operator, according to the methods adopted in particular for the containment of COVID-19 infections.

Conveniently, the port 60, or the ports, may be defined by one or more horizontal slots made in the separation panel 70 and having a size suitable for inserting at least A4 format documents thereinside, including identification documents, with a height sufficient for insertion also of stapled and bound sheets, for example of approximately 5 cm.

The port 60, or the ports, will allow the documents to be inserted inside a compartment 80 present in the supporting structure 20 and in which the acquisition means 30 and the supplying means 50 will be housed, at least in part.

The invention represents a sort of real-time electronic “paper pass” in which inserting documents on the user side allows them to be optically acquired for their subsequent transformation into files.

Preferably, the supplying means 50 may comprise or consist of a printer 90, placed on the bottom of the compartment 80, which will allow any document the system or the operator wishes to deliver to the user to be printed and supplied.

It will be possible to provide at least two versions which differ substantially in the methods of entering the documents.

Preferably, the port 60 will be arranged in front of the position in which the user will normally be placed, in correspondence with which the support surface 100 may also be present to facilitate both the positioning and the acquisition of documents.

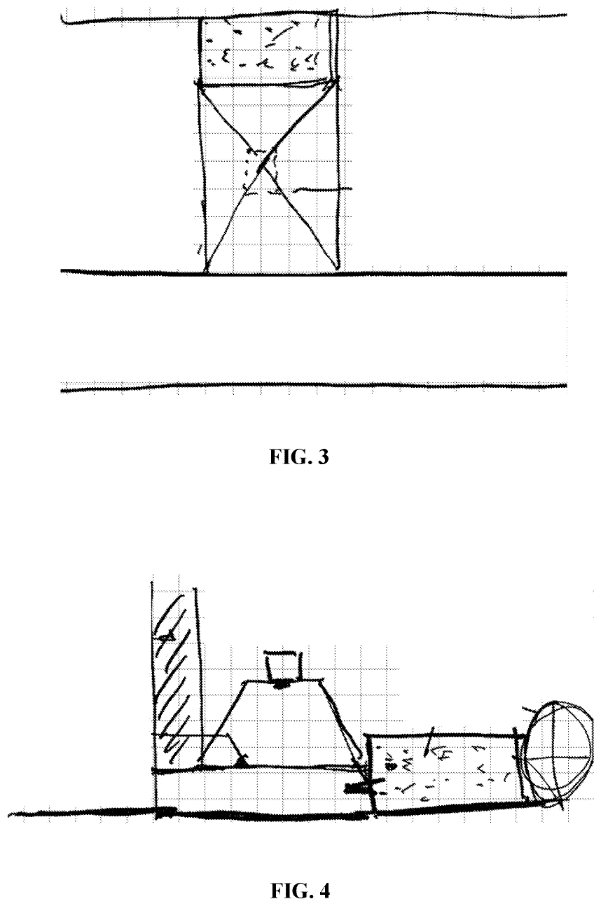

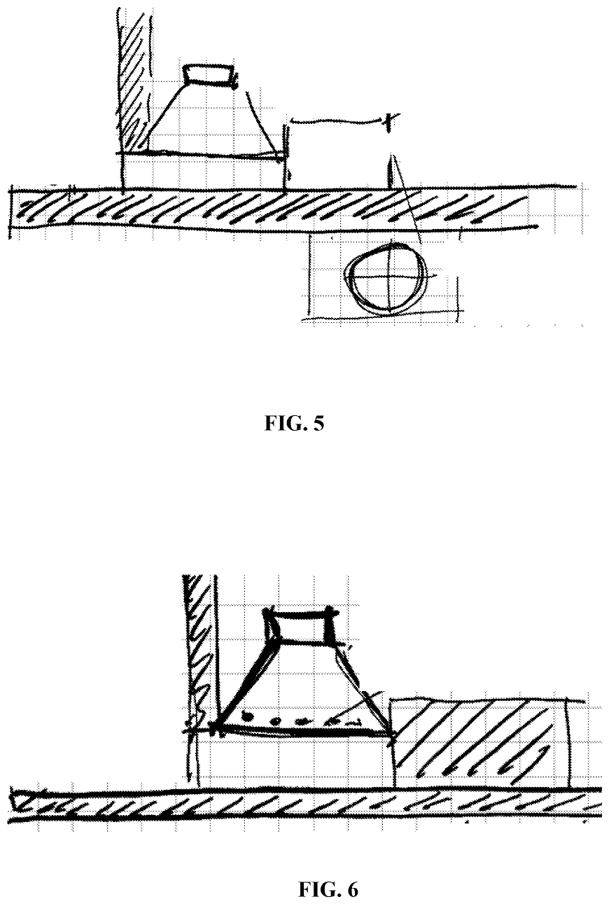

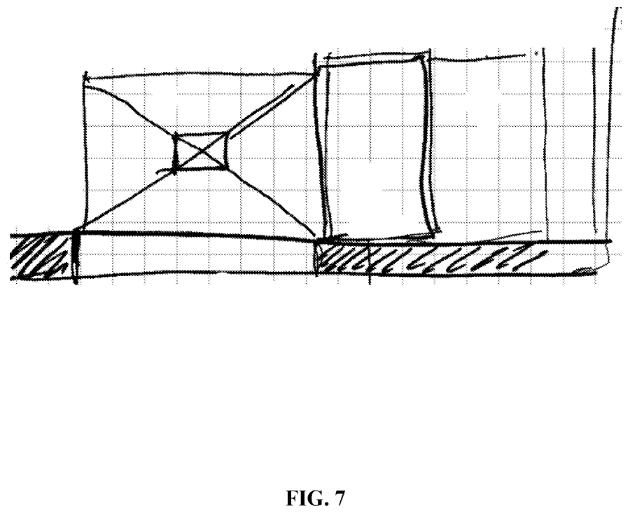

In particular, according to a first version, more clearly visible from FIG. 3, the port 60 will be sized in such a way that, both in acquisition and in supplying, the A4 sheet must be positioned perpendicular to the user, i.e. with its short side placed frontally. In a second version, visible more clearly in FIG. 7, the port 60 will be sized to allow the insertion and dispensing of the A4 sheet in a rotated position compared to the previous one, i.e. with the long side in a frontal position.

This configuration will allow the depth of the apparatus 10 to be reduced and, furthermore, will allow for a wider port 60 and a shallower document support surface 100, so as to facilitate the recovery of small documents, such as personal cards.

Preferably but not exclusively, the printer 90 will preferably be a no-frame thermal printer with 150 roll sheets, for example A4 format, which will be gradually cut to the exact size, depending on the type of document to be printed.

Depending on the version used, i.e. with frontal or lateral insertion of the sheet, the printer 90 may be positioned to the right or left of the input/output port 60 so as to facilitate loading of the paper at the end of the roll.

In this way, ordinary maintenance operations will also be significantly reduced as it will only be necessary to load the paper inside the printer 90.

In the version with front insertion, the width of the port 60 can be approximately 22 cm, while in the version with lateral insertion it will be approximately 31 cm, thus facilitating both the insertion and the recovery, for example, of cards that they need scanning or small documents, which will be more easily recoverable with a wider entry opening.

Furthermore, on the innermost part of the support surface 100 there may be a slot which will accommodate the outlet of the supplying means.

Therefore, a teller machine manned remotely by an operator and provided with the above apparatus will allow the user to insert a document into the port 60 as he/her would have done in a traditional station, to always receive it in a frontal position, from the same port 60 or from a different port.

The optical acquisition means 30 may comprise a document acquisition camera 110, such as an autofocus microcamera illuminated by appropriate lighting means, for example two LED strips 160, which will allow any document to be acquired, be it loose, stapled or bound, without it is necessary to proceed with the removal of the stapling or binding and always guaranteeing the maximum acquisition quality and no possibility of paper jamming, which instead represents the main problem of scanners. The camera 110 may be a 5 or 8 megapixel camera, placed vertically at the top of a supporting structure 130 shaped as a truncated pyramid placed above and perpendicular to an acquisition plane 140 on which the document to be acquired will be placed and having inside proper lighting means, for example 120 LED lights.

The same camera 110 for document acquisition may also be suitable for acquisition of barcodes, QR codes, even complex ones, or other codes, with a speed similar to the supermarket code reader so as to return the digits contained therein to the operator for the completion of the CRM operation.

The material of the truncated pyramidal supporting structure 130 may be sheet steel of adequate thickness painted white on the inside and illuminated by two LED strips 160 facing upwards in the inner part of the same truncated pyramidal supporting structure 130.

The system or the remote operator, seeing the image to be acquired, may take one or more photos to generate a file, for example in PDF, JPG, TIFF or other set format.

The processing means will instead be designed to allow a real operator operating remotely, or even virtually, to receive the documentation in real time on his CRM station through the acquisition means 30, with the possibility also of saving the documents in his CRM or in an archive folder.

Conveniently, the centralized system designed to manage the machine will not allow data storage, guaranteeing absolute protection of the user's privacy.

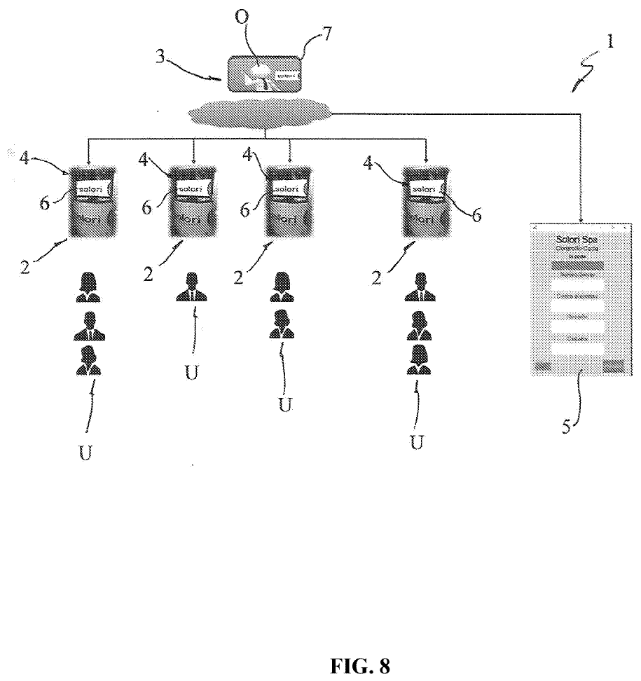

The teller machine may be integrated within a system 1, schematized in FIG. 8, comprising a plurality of local teller machine 2 accessible each in a respective room by a plurality of users and suitable of being located in corresponding rooms, public areas and/or or private ones accessible by users U for whom the service to be managed is intended.

The number of teller machines 2 may vary according to needs and in particular the geographical area to be covered, as well as the availability of rooms or areas in which they can be placed, without particular theoretical limitations.

The system 1 also comprises one or more remote workstations 3, each manned by an operator O, suitable to be placed in remote communication with the local teller machine 2 so that each remote workstation 3 may connect with only one teller machine 2 at a time.

The workstations 3 can all be located in the same place, for example a central or peripheral headquarters of the company or entity providing the service, or they can be arranged in different places as it will not be necessary to put them in direct communication with each other.

Each teller machine 2 is also associated with video presence communication means 4 designed to remotely connect the workstations 3 with the local teller machines 2.

There is also a central management unit 5 remotely connected to each teller machine 2 in order to acquire through them a request for the provision of a service from individual users U.

The central management unit 5 will be designed to receive the requests and sort them into one or more queues according to one or more predetermined parameters so as to temporarily associate each of the workstations 3 with a corresponding local teller machine 2 according to a predetermined supplying order based on of these parameters. For example, according to a simplified management method, time may be the only association parameter provided, in such a manner that the user U who first made a request for service provision will be served, regardless of the type of service requested or the place or type of teller machine 2 from which the request came.

However, according to further operating methods, the central management unit 5 may be designed to organize requests into multiple queues, differentiated for example on the basis of the time of the request but also on the type of service requested or any priorities or other exceptions.

Furthermore, according to a first operating method, the remote workstations 3 can be associated indifferently with each one of the teller machines 2 regardless of the type of service requested.

According to different operating modes, the operation of the individual remote workstations 3 can be differentiated based on the types of services that can be provided and/or the location of the individual local teller machines 2.

Purely by way of example, one or more workstations 3 may be reserved for specific services or may be excluded from the provision of certain services, in particular services that require specific skills, which instead may only be entrusted to a limited number of workstations 3.

Consequently, the central management unit 5 may separate the requests into different queues also depending on the type of request and the availability of the various remote workstations 3.

Regardless of the specific operation of the individual remote workstations 3, the system 1 will have the advantage of aggregating the various local offices equipped with the teller machines 2 into a single virtual central office, so as to maximize the productivity of the individual workstations 3 and significantly reduce the costs related to the workforce, with reductions of up to 60% or more compared to average costs.

In order to simulate as much as possible the local presence of the operator O associated with the remote workstation 3, the video presence communication means 4 will comprise an HD monitor 6 associated with each of the local teller machines 2 and connected remotely to video acquisition means 7, preferably in HD, associated with remote workstations 3.

Possibly, each of the remote workstations 3 may be equipped with at least two monitors, the first of which will be used by the operator O for the video presence call while a second monitor will be used by the same operator O to view his management software.

Furthermore, the HD monitor 6 will be sized to transmit the real-size image of the operator, in full or partial form, for example transmitting only the face or a half-length portrait. As an example, monitor 6 will be 50 inches.

Furthermore, the video presence communication means 4 of the local teller machines 2 will preferably be connected to the video acquisition means 7 via a fiber optic internet network or other high-speed data communication network, with connection reliability of 99%.

In this way, unlike a video conference, it will be possible to obtain a video presence experience that creates the illusion that the remote operators O are in the same place as the user U using the teller machine 2, creating direct visual contact which will also produce emotional involvement.

According to a further variant, the monitor can be replaced with glass associated with a hologram generator which will further amplify for the user the sensation of having an operator in the presence.

To increase the effect of the real presence of the operator O, each teller machine 2 will comprise a support structure, for example made of wood, equipped with the monitor 6.

In a first configuration, the monitor 6 may be placed at a height such as to allow the user U to have the face of the operator O at face height; for example, the support structure may have a support surface for the monitor 6 located approximately 120 cm from the ground, even if this height is purely illustrative and not restrictive of the invention.

In a second configuration, the structure may be designed as a consultancy station in which user U remains seated and therefore monitor 6 will be placed lower.

Regardless of the configuration of the support structure, each local teller machine 2 will also be provided with the means for the optical acquisition 30 of documents.

For example, the means for the optical acquisition 30 of documents may comprise an optical scanner 170 for the acquisition of any type of document, such as an identity document or any other document functional to carrying out the procedure and providing the service, for example provided with a barcode or other alphanumeric or graphic code, such as a QR code or similar, for automatic recognition of the document. Alternatively or in addition, the means for the optical acquisition of documents may comprise a front video camera, preferably at high resolution, which can simultaneously acquire the image of the user's identity document and an image of the user's face so as to allow the operator O in the remote workstation 3 to verify the identity of the user U, also allowing acquisition of one or more photographs of the user U, to generate a file which will be transmitted to the central management unit 5 which will storage it within a special memory.

Means for the digital acquisition of data may also be provided, such as devices for signing any documentation in digital format with substitute conservation using the remote digital signature with OTP, devices for video recording of consultancy sessions and all that is necessary for the preservation of the counter session.

The local teller machines 2 may also be provided with means for biometric recognition of users.

Furthermore, possibly the teller machines 2 may be implemented with further devices, such as printers, POS devices for making payments via ATM or credit cards, ATM terminals for dispensing money or making payments and top-ups, without particular limitations.

The power supply of each local teller machines 2 can be obtained by connection to the electricity grid and/or by means of autonomous power systems, with possible buffer batteries and the presence of UPS systems.

Last but not least, each local teller machines 2 may be implemented with a GSM/4G backup system for data.

For the automatic management of queues and to increase the safety of operations, and in particular to allow the remote operator O to ascertain the identity of the user U, each local teller machines 2 may be provided with a unique identification code placed directly on the supporting structure.

For example, the code will consist of a QR code within which the name of the office or place where the local teller machines 2 is present and the type of service that can be provided by the local teller machines 2 will be configured.

In this way, user U will only have to scan the QR code with his/her mobile phone to instantly receive a message, for example an SMS, from the central unit 5 for remote queue management, which will inform him/her of his/her position in the general queue between all the teller machines 2, possibly also indicating an estimate of the waiting time.

In the case of a user U without a smartphone or other mobile communication device enabled for automatic code reading, they will be asked to send a text message containing a different alphanumeric identification code of the teller machines 2, having the same value as the QR code, always shown on the structure of the teller machines 2, to a telephone number indicated on teller machines 2.

The central remote queue management unit 5 will also indicate the possible operation of the workstations 3 in other locations so that the user U is aware that the system 1 is in operation even though he/her does not see other users in the same place.

At the time of his turn, user U will receive a message, for example an SMS, Whatsapp message or other notification, also via a specific APP, which will invite him to approach the teller machine 2 and enter an identification code just received via message.

The recognition code will be the key to activate the teller machine 2 and start communicating with the remote operator O assigned by the central management unit 5 on the basis of the queue.

Conveniently, the central remote queue management unit 5 will constantly report to each remote workstation 3 the situation in the various teller machines 2, i.e. the number of users U waiting for each teller machine 2.

At this point the session at the teller machine 2 may begin by activating the video presence session.

Operator O will first ask user U to show an identification document, taking two photos of the user's face alongside the identification document via the front camera. The appropriately approved file will be kept in the archive, linked to the coded session for two or three years.

The system may provide a second safety level for recognition which may include the forwarding of an OTP code to mobile phone of the user U, inviting him to type it on the local teller machine 2.

Once the remote recognition formalities have been completed, it is possible to move on to the actual counter session.

1. A teller machine for supplying remote services, comprising a supporting structure (20) having a workstation (3) for acquisition and supplying of documents and/or requests by a user,
wherein said workstation (3) comprises at least one apparatus (10) for the acquisition and supplying of documents comprising:
acquisition means (30) for the optical acquisition of documents;
processing means for processing acquired documents;
supplying means (50) for supplying documents;
wherein said supporting structure (20) has at least one port (60) for inserting documents by a user to feed said acquisition means (30) and at least one port (60) for supplying documents to the same user by said supplying means (50).

2. The teller machine as claimed in claim 1, comprising video presence communication means (4) associated with said supporting structure (20) and suitable for remotely putting a user in contact with a real or virtual operator assigned to providing the service.

3. The teller machine as claimed in claim 2, comprising a central management unit (5) remotely connected to said video presence communication means and suitable to receive requests for supplying of services from a user and to temporarily associate said workstation (3) with a real or virtual operator.

4. The teller machine as claimed in claim 3, wherein said central management unit (5) is suitable to put the operator in communication with said optical acquisition means (30) of documents for checking them and for controlled acquisition of documents.

5. The teller machine as claimed in claim 4, wherein said supporting structure (20) has a single port (60) suitable for allowing both the acquisition and supplying of documents.

6. The teller machine as claimed claim 5, wherein said at least one port (60) is sized to acquire and/or supply at least one A4 sheet.

7. The teller machine as claimed in claim 6, wherein said acquisition means (30) comprise a document acquisition plane (140) accessible from the outside through said port (60) and a document acquisition camera (100) placed above said acquisition plan (140).

8. The teller machine as claimed in claim 7, wherein said camera (110) is a 5 or 8 megapixel autofocus microcamera illuminated by LED type lighting means (160) and placed at the top of a supporting structure (110) in the shape of a truncated pyramid provided with means for illuminating said acquisition plane (140).

9. The teller machine as claimed in claim 1, wherein said supplying means (50) comprise a printer (90) located downstream of said acquisition means (30) with respect to said port (60).

10. The teller machine as claimed in claim 9, wherein said printer (90) is a no-frame printer with roller sheets capable of being cut to the exact size based on the type of document.
